(19) United States
(12) Patent Application Publication
(10) Pub. No.: US 2015/0002475 A1
(43) Pub. Date: Jan. 1, 2015

(54) MOBILE DEVICE AND METHOD FOR CONTROLLING GRAPHICAL USER INTERFACE THEREOF

(71) Applicant: Industrial Technology Research Institute, Hsinchu (TW)

(72) Inventors: Kuo-Tung Tiao, Hsinchu County (TW); Tzuan-Ren Jeng, Hsinchu City (TW); Hsien-Chang Lin, Taipei City (TW); Chia-Chen Chen, Hsinchu City (TW); Shys-Fan Yang-Mao, Hsinchu County (TW); Wen-Jun Zeng, Hsinchu County (TW); Yao-Lien Wang, New Taipei City (TW); Kuo-Chung Huang, Taichung City (TW)

(21) Appl. No.: 14/221,269

(22) Filed: Mar. 20, 2014

Related U.S. Application Data
(60) Provisional application No. 61/839,881, filed on Jun. 27, 2013.

(51) Int. Cl. G06F 3/042

(52) U.S. Cl. CPC G06F 3/0425
USPC 345/175

(57) ABSTRACT

A mobile device is provided, which includes a camera unit, a sensor unit, a see-through display, and a processor. The camera unit takes an image of a finger and a surface. The sensor unit generates a sensor signal in response to a motion of the finger. The taking of the image and the generation of the sensor signal are synchronous. The see-through display displays a GUI on the surface. The processor is coupled to the camera unit, the sensor unit, and the see-through display. The processor uses both of the image and the sensor signal to detect a touch of the finger on the surface. The processor adjusts the GUI in response to the touch.

### CROSS-REFERENCE TO RELATED APPLICATION

This application claims the priority benefits of U.S. provisional application Ser. No. 61/839,881, filed on Jun. 27, 2013. The entirety of the above-mentioned patent application is hereby incorporated by reference herein and made a part of this specification.

### BACKGROUND

1. Field of the Disclosure

The disclosure relates to a mobile device and a method for controlling a graphical user interface (GUI) of the mobile device.

2. Description of the Related Art

In the recent years, smart computing devices have evolved gradually from desktop computers to mobile devices. Some of the latest smart mobile devices are designed as wearable devices and they are getting more and more diverse, such as augmented reality (AR) glasses, smart watches, control bracelets, and control rings, etc.

The smart wearable devices interact with their users through cameras, touch sensors, voice sensors, or motion sensors. The purpose of these devices is providing more means for their users to complete specific tasks. One of the factors that can affect the convenience and efficiency of smart mobile devices is the user interface.

### SUMMARY

This disclosure provides a mobile device and a method for controlling a GUI of the mobile device. The mobile device is a wearable device comprising an easy, intuitive and interactive GUI and is capable of conveying real sense of touches to the user.

In an embodiment of the disclosure, a mobile device is provided, which comprises a camera unit, a sensor unit, a see-through display, and a processor. The camera unit takes an image of a finger and a surface. The sensor unit generates a sensor signal in response to a motion of the finger. The taking of the image and the generation of the sensor signal are synchronous. The see-through display displays a GUI on the surface. The processor is coupled to the camera unit, the sensor unit, and the see-through display. The processor uses both of the image and the sensor signal to detect a touch of the finger on the surface. The processor adjusts the GUI in response to the touch.

In an embodiment of the disclosure, a method for controlling a GUI of a mobile device is provided. The method comprises the following steps: taking an image of a finger and a surface; generating a sensor signal in response to a motion of the finger, wherein the taking of the image and the generation of the sensor signal are synchronous; displaying the GUI on the surface; using both of the image and the sensor signal to detect a touch of the finger on the surface; and adjusting the GUI of the mobile device in response to the touch.

### BRIEF DESCRIPTION OF DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram showing a mobile device according to an embodiment.

FIG. 2 is a schematic diagram showing an index hand and a reference hand of a user according to an embodiment.

FIG. 3 is a flow chart showing a method for controlling a GUI of a mobile device according to an embodiment.

FIG. 4 is a flow chart showing a method for controlling a GUI of a mobile device according to another embodiment.

FIG. 5 is a schematic diagram showing a preset motion performed by a user according to an embodiment.

FIG. 6 to FIG. 12 are schematic diagrams showing preset gestures performed by a user and their corresponding preset functions according to various embodiments.

### DETAILED DESCRIPTION OF DISCLOSED EMBODIMENTS

Below, embodiments will be described in detail with reference to accompanying drawings so as to be easily realized by a person having ordinary knowledge in the art. The inventive concept may be embodied in various forms without being limited to the embodiments set forth herein. Descriptions of well-known parts are omitted for clarity, and like reference numerals refer to like elements throughout.

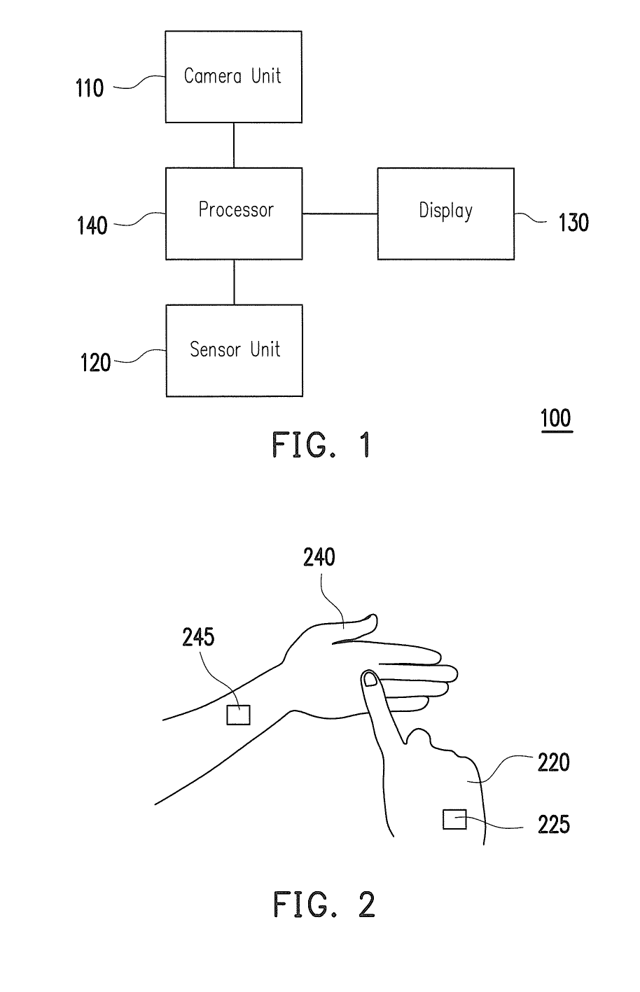

FIG. 1 is a schematic diagram showing a mobile device 100 according to an embodiment. The mobile device comprises a camera unit 110, a sensor unit 120, a display 130, and a processor 140. The processor 140 is coupled to the camera unit 110, the sensor unit 120, and the display 130.

The mobile device 100 may be designed as a head-mounted device, such as a pair of glasses. The display 130 may be a see-through display disposed as the lenses of the glasses. The camera unit 110 may take images of the environment observed by the user of the mobile device 100. When the processor 140 identifies a surface in the image, such as a desktop, a wall, or a palm of the user, the display 130 may project a virtual GUI of the mobile device 100 into the eyes of the user by refraction. The virtual GUI is not projected on the surface. The user still can see the physical surface through the GUI and the display 130. Consequently, what the user sees is the physical surface overlaid with the virtual GUI.

The user may touch the surface with a fingertip to interact with the mobile device 100. The user feels like he or she is touching the GUI displayed by the display 130. The physical surface provides real sense of touch to the user. The processor 140 detects the position of the touch by identifying and tracking the fingertip in the image taken by the camera unit 110. The sensor unit 120 may detect physical phenomenon such as sound, pressure or vibration caused by the fingertip of the user touching the surface, so that the processor 140 can check whether the touch occurs or not by analyzing the sensor signal generated by the sensor unit 120.

The hand used by the user to touch the surface is defined as the index hand, while the hand whose palm serves as the surface is defined as the reference hand. FIG. 2 is an example showing the index hand 220 and the reference hand 240.

The sensor unit 120 may comprise one or more sensors. Each sensor may be disposed at one of three positions. The first position is the main body of the mobile device 100, such as the aforementioned glasses. The second position is on the index hand, such as the position 225 in FIG. 2. The third position is on the reference hand, such as the position 245 in FIG. 2. When the sensor unit 120 comprises multiple sensors, the sensors may concentrate at one of the three positions, or distribute over two of the three positions, or distribute over all of the three positions. Each sensor may generate a sensor signal in response to the motion of the finger of the user and transmits the sensor signal to the processor 140 for analysis. The remote sensors at the positions 225 and 245 may transmit their sensor signals to the processor 140 through a wireless communication protocol such as Bluetooth.

The sensor unit 120 may comprise an electromyography (EMG) sensor, a vibration sensor, a pressure sensor, a microphone, a gyroscope sensor, an accelerometer, or any combination of the aforementioned sensors. The EMG sensor generates electromyographic signals as the sensor signal in response to contractions of muscles of the user. The vibration sensor generates the sensor signal in response to vibrations caused by the touch. The pressure sensor generates the sensor signal in response to pressures caused by the touch. The pressure sensor may need to be disposed on the palm or the fingertip to detect the pressures. The microphone generates the sensor signal in response to sounds caused by the touch. The gyroscope sensor and the accelerometer may generate the sensor signal in response to motions of the finger, the index hand, or the reference hand.

The mobile device 100 may use various techniques to eliminate interferences of noises in either the image or the sensor signal in order to prevent false touch events. For example, the camera unit 110 may comprise an infrared (IR) light source and an IR camera. The IR light source may provide IR lighting on the finger and the IR camera may take IR images of the finger. Since the finger is much closer to the IR camera than the background is and therefore the finger is much clearer in the IR images than the background is, it is easy to filter out the background noises in the IR images.

The image taken by the camera unit 110 is prone to uncertainty of the occurrence of the touch because the index hand and the reference hand in the image are usually arranged like those two hands in FIG. 2. The sensor signal is prone to frequent noises from the environment or motions of the index hand other than the touch. Consequently, checking whether the touch occurs or not is usually difficult based on the image or the sensor signal alone. The processor 140 may use the sensor signal to resolve the uncertainty of the image and meanwhile use the image to filter out the noises in the sensor signal. For example, the processor 140 may ignore the sensor signal and does not attempt to detect the touch when the processor 140 cannot identify the finger in the image or when the fingertip is not in a touch-operable area of the GUI to prevent false touch events. In addition, the sensor signal can shorten the response time of the touch of the user.

The camera unit 110 may comprise one or more time-of-flight (TOF) cameras, one or more dual color cameras, one or more structure light ranging cameras, one or more IR cameras and one or more IR light sources, or any combinations of the aforementioned cameras and light sources. When the camera unit 110 comprises two cameras, the two cameras may take stereo images of the finger and the surface. The processor 140 may use the stereo images to estimate the distance between the finger and the surface. The processor 140 may use the distance as an auxiliary to detect the touch of the finger of the user on the surface.

As mentioned previously, the sensor unit 120 may comprise a gyroscope sensor and/or an accelerometer configured to detect motions of the finger. The processor 140 may detect the touch according to the image and one or more changes of the motion of the finger. When the fingertip touches the surface, the motion of the finger may stop suddenly or slow down suddenly, or the finger may vibrate. The processor 140 may detect the touch by analyzing the sensor signal generated by the gyroscope sensor and/or the accelerometer to detect those changes of the motion of the finger.

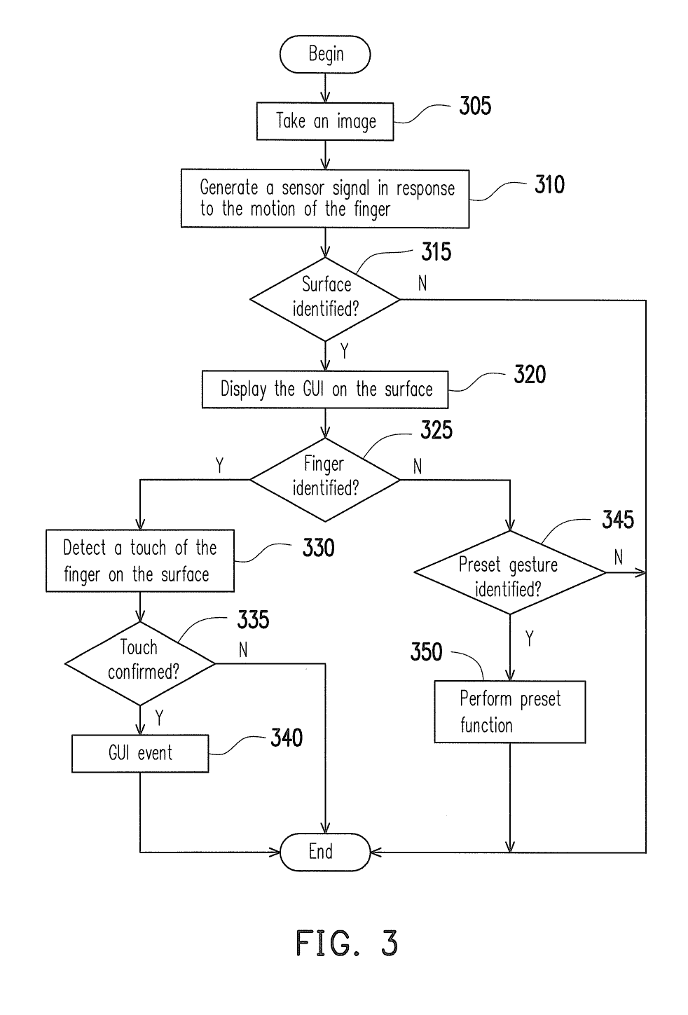

FIG. 3 is a flow chart showing a method for controlling the GUI of the mobile device 100 according to an embodiment. In step 305, the camera unit 110 takes an image. The image may comprise the finger or the surface. In step 310, the sensor unit 120 generates a sensor signal in response to the motion of the finger. The taking of the image and the generation of the sensor signal are synchronous. In step 315, the processor 140 checks whether the surface can be identified in the image or not. The processor 140 ignores the sensor signal and does not attempt to detect the touch when the processor 140 fails to identify the surface in the image. The display 130 displays the GUI of the mobile device 100 on the surface in step 320 when the processor 140 identifies the surface in the image.

In step 325, the processor 140 checks whether the finger of the user can be identified in the image or not. When the processor 140 can identify the finger in the image, the processor 140 uses both of the image and the sensor signal to detect a touch of the finger on the surface in step 330. In step 335, the processor 140 checks whether the occurrence of the touch is confirmed or not. When the touch is confirmed, the processor 140 adjusts the GUI in response to the touch in step 340 to provide visual feedback of the touch to the user.

When processor 140 fails to identify the finger in the image in step 325, the processor 140 ignores the sensor signal and does not attempt to detect the touch and the flow proceeds to step 345. In step 345, the processor 140 uses the image to check whether a preset gesture of the palm of the reference hand can be identified in the image or not. When the processor 140 identifies the preset gesture of the palm in the image, the processor 140 may perform a preset function in response to the preset gesture in step 350.

The processor 140 may identify and track the palm in the image according to characteristics of the palm such as color, feature and shape. The processor 140 may identifies the preset gesture of the palm according to at least one of change of shape of the palm in the image, change of position of the palm in the image, and change of motion of the palm in the image. The position of the palm may comprise the distance from the palm to the camera unit 110 or the surface when the camera unit 110 can take stereo images.

The processor 140 may use both of the image and the sensor signal to identify the preset gesture of the palm in the image. For example, when the sensor unit 120 comprises an EMG sensor, the sensor signal generated by the EMG sensor may indicate contractions of finger muscles resulting from change of gesture of the palm. When the sensor unit 120 comprises a vibration sensor, the sensor signal generated by the vibration sensor may indicate vibrations resulting from change of gesture of the palm. In addition to identify the gesture of the palm in the image, the processor 140 may analyze the magnitude and/or the waveform of the sensor signal to identify the gesture of the palm.

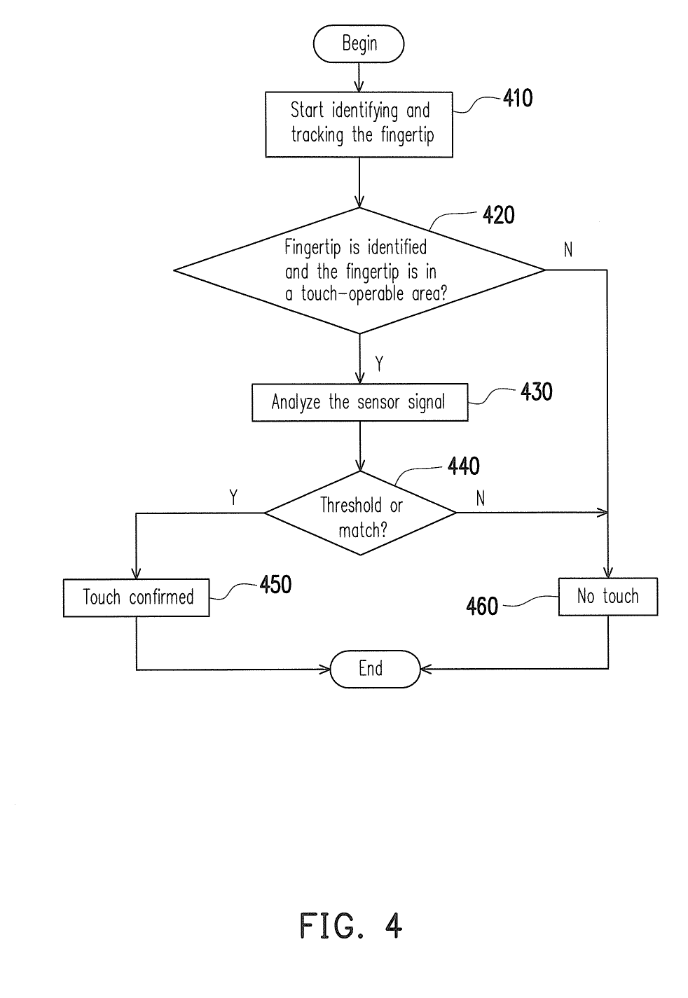

FIG. 4 is a flow chart showing some details of step 330 in FIG. 3 according to an embodiment. In step 410, the processor 140 start identifying and tracking the fingertip of the finger of the user. The processor 140 may use characteristics of the fingertip in the image such as color, feature and shape to identify and track the fingertip.

In step 420, the processor 140 checks whether or not the fingertip is identified in the image and the fingertip is in a touch-operable area of the GUI. When processor 140 fails to identify the fingertip or when the fingertip is in a non-touch-operable area of the GUI, the processor 140 ignores the sensor signal and does not attempt to detect the touch. In this case, the processor 140 determines that there is no touch event in step 460. When processor 140 identifies the fingertip and the fingertip is in a touch-operable area of the GUI, the processor 140 analyzes the sensor signal to detect the touch in step 430.

The processor 140 may detect the touch according to the magnitude of the sensor signal. In this case, the processor 140 checks whether the magnitude of the sensor signal is larger than a preset threshold or not in step 440. When the magnitude of the sensor signal is larger than the preset threshold, the processor 140 confirms the touch in step 450. Otherwise, the processor 140 determines that there is no touch event in step 460.

Temperature and humidity affect the elasticity of human skin. The elasticity of human skin affects the vibration detected by the vibration sensor in the sensor unit 120. In an embodiment, the sensor unit 120 may comprise a temperature sensor configure to measure the ambient temperature of the finger and the sensor unit 120 may further comprise a humidity sensor configure to measure the ambient humidity of the finger. The processor 140 may adjust the preset threshold according to the ambient temperature and the ambient humidity to improve the accuracy of the touch detection.

Alternatively, the processor 140 may detect the touch according to the waveform of the sensor signal. In this case, the processor 140 checks whether the waveform of the sensor signal matches a preset waveform or not in step 440. When the waveform of the sensor signal matches the preset waveform, the processor 140 confirms the touch in step 450. Otherwise, the processor 140 determines that there is no touch event in step 460.

A multiple click of the finger, such as a double click or a triple click, on the surface is difficult to detect based on the image alone. On the other hand, the detection of a multiple click is easy based on both of the image and the sensor signal. The processor 140 may detect a multiple click on the surface by analyzing the image to confirm the position of the multiple clicks and analyzing the sensor signal to confirm the number of clicks of the finger on the surface, and then the processor 140 may perform a preset function in response to the multiple clicks. The processor 140 may analyze the sensor signal to detect the multiple clicks only when the fingertip is in a touch-operable area of the GUI to filter out unwanted noises in the sensor signal.

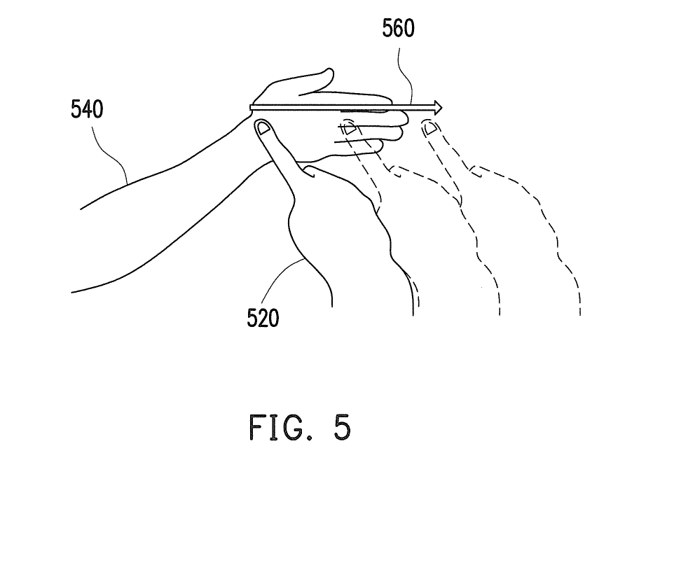

The user may trigger a preset function by performing a preset motion on the surface, such as a straight slide on the surface or plotting the letter “s” on the surface. For example, FIG. 5 is a schematic diagram showing a preset motion performed by the user according to an embodiment. The preset motion shown in FIG. 5 is a straight slide 560 of a finger of the index hand 520 on the palm of the reference hand 540.

Such a preset motion on the surface is difficult to detect based on the image alone because it is difficult to confirm the continued contact of the finger on the surface. On the other hand, the detection of the preset motion on the surface is easy based on both of the image and the sensor signal because the sensor unit 120 can easily detect the continued contact. The processor 140 may detect a preset motion of the finger on the surface by tracking the motion of the finger in the image and analyzing the sensor signal to confirm the continued contact of the finger on the surface, and then the processor 140 may perform a preset function in response to the preset motion.

For example, the mobile device 100 may record photographs and profiles of friends of the user. The camera unit 110 may take an image of a person and the processor 140 may compare the image with the photographs of the friends to identify the person. The user may select a file and perform the preset motion. The preset function associated with the preset motion may be sending the file to a mobile device owned by the person or an account of the person on a remote server.

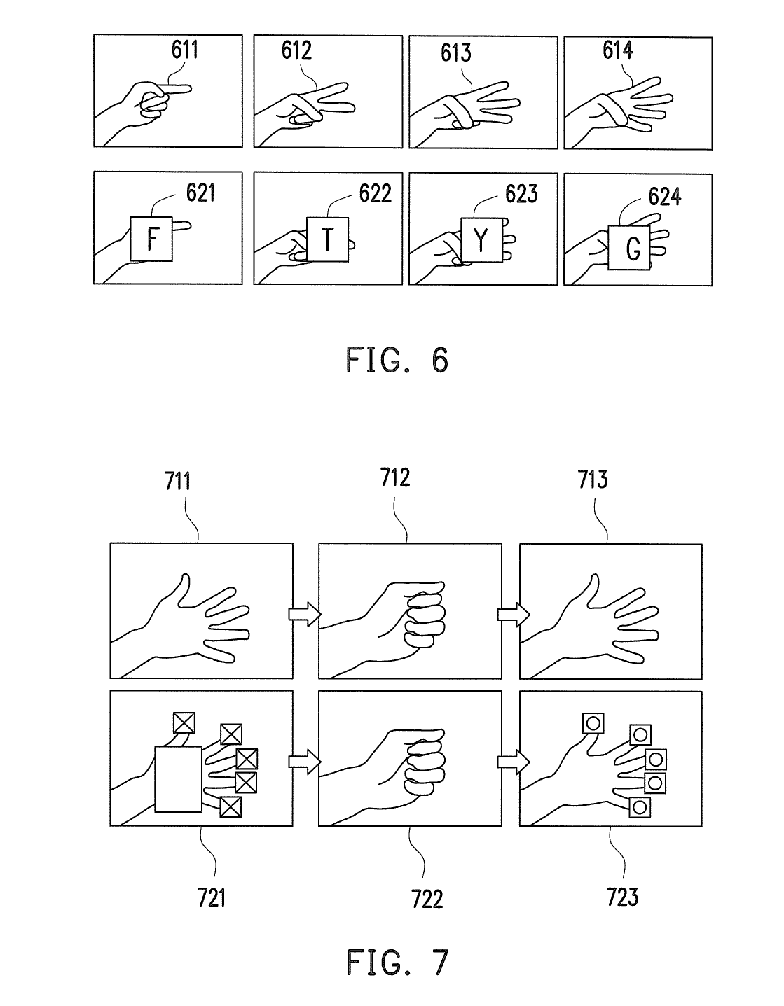

The following figures from FIG. 6 to FIG. 12 are examples of the preset gesture and the preset function mentioned in steps 345 and 350 in FIG. 3. Each of the figures from FIG. 6 to FIG. 12 shows two rows of images. The top row of images shows the changes of gestures of the palm of the reference hand in the images taken by the camera unit 110. The bottom row of images shows the changes of the GUI of the mobile device 100 observed by the user through the see-through display 130. As mentioned previously, the palm is overlaid with the GUI in the vision of the user.

FIG. 6 is a schematic diagram showing preset gestures performed by the user and the preset functions corresponding to the preset gestures according to an embodiment. Each preset gesture indicates a number and the corresponding preset function is executing an application corresponding to the number. As shown in FIG. 6, the mobile device 100 executes the first application 621 when the processor 140 identifies the gesture 611 indicating the number one. The mobile device 100 executes the second application 622 when the processor 140 identifies the gesture 612 indicating the number two. The mobile device 100 executes the third application 623 when the processor 140 identifies the gesture 613 indicating the number three. The mobile device 100 executes the fourth application 624 when the processor 140 identifies the gesture 614 indicating the number four.

FIG. 7 is a schematic diagram showing a preset gesture performed by the user and the preset function corresponding to the preset gesture according to an embodiment. In this embodiment, the user is operating a menu with multiple levels. The preset gesture is closing the palm into a fist and then opening the palm. The corresponding preset function is returning to the previous level of the menu. As shown in FIG. 7, the display 130 displays a level of a menu in the GUI 721 when the user opens the palm of his/her reference hand in the image 711. The menu disappears in the GUI 722 when the user closes the palm into a fist in the image 712. The display 130 displays the previous level of the menu in the GUI 723 when the user opens the palm again in the image 713.

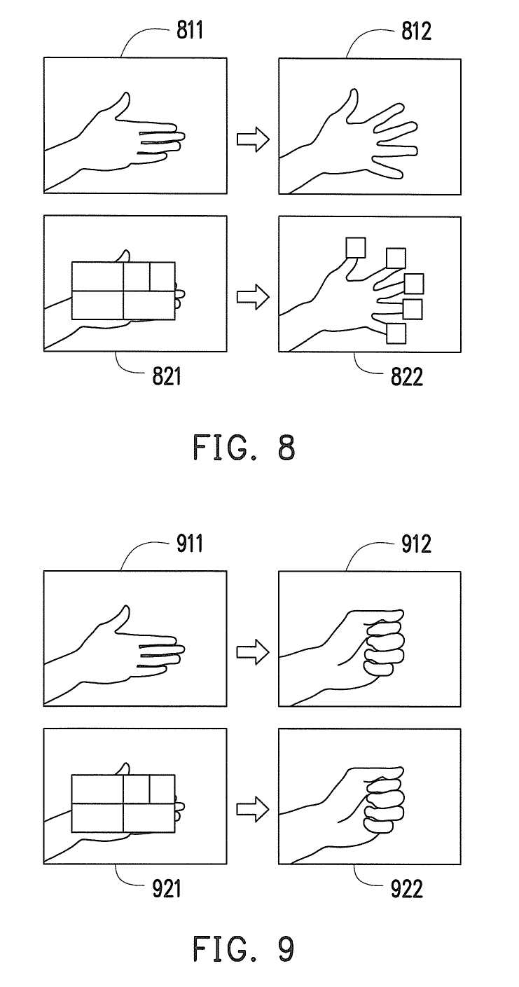

FIG. 8 is a schematic diagram showing a preset gesture performed by the user and the preset function corresponding to the preset gesture according to an embodiment. The preset gesture is spreading the fingers of the palm. The corresponding preset function is distributing the options of the current menu to the tips of the fingers such that the options are farther apart and easier to touch. As shown in FIG. 8, the options in the menu in the GUI 821 are closely packed when the fingers of the palm are close together in the image 811. The options in the menu in the GUI 822 are moved to distribute at the fingertips when the fingers of the palm are spread open in the image 812.

FIG. 9 is a schematic diagram showing a preset gesture performed by the user and the preset function corresponding to the preset gesture according to an embodiment. The preset gesture is closing the palm into a fist. The corresponding preset function is closing the current application. As shown in FIG. 9, the display 130 displays the current application in the GUI 921 when the processor 140 identifies an open palm in the image 911. The processor 140 closes the current application in the GUI 922 when the processor 140 identifies a closed fist in the image 912.

FIG. 10 is a schematic diagram showing a preset gesture performed by the user and the preset function corresponding to the preset gesture according to an embodiment. The preset gesture is moving the finger closer to or farther from the surface. The preset function is zooming out or zooming in the currently selected object in the GUI. The processor 140 may estimate the distance between the finger of the index hand and the surface according to stereo images when the camera unit 110 can take stereo images. The processor 140 may zoom in or zoom out the object according to the distance. Alternatively, since the size of the finger of the index hand in the images changes in response to the distance, the processor 140 may zoom in or zoom out the object according to the size of the finger in the images. As shown in FIG. 10, the display 130 displays a normal view 1021 of the object when the finger of the index hand exhibits a small size in the image 1011. The display 130 displays a zoomed-in view 1022 of the object when the finger exhibits a large size in the image 1012. The display 130 displays the normal view 1021 of the object again when the finger resumes the small size in the image 1013.

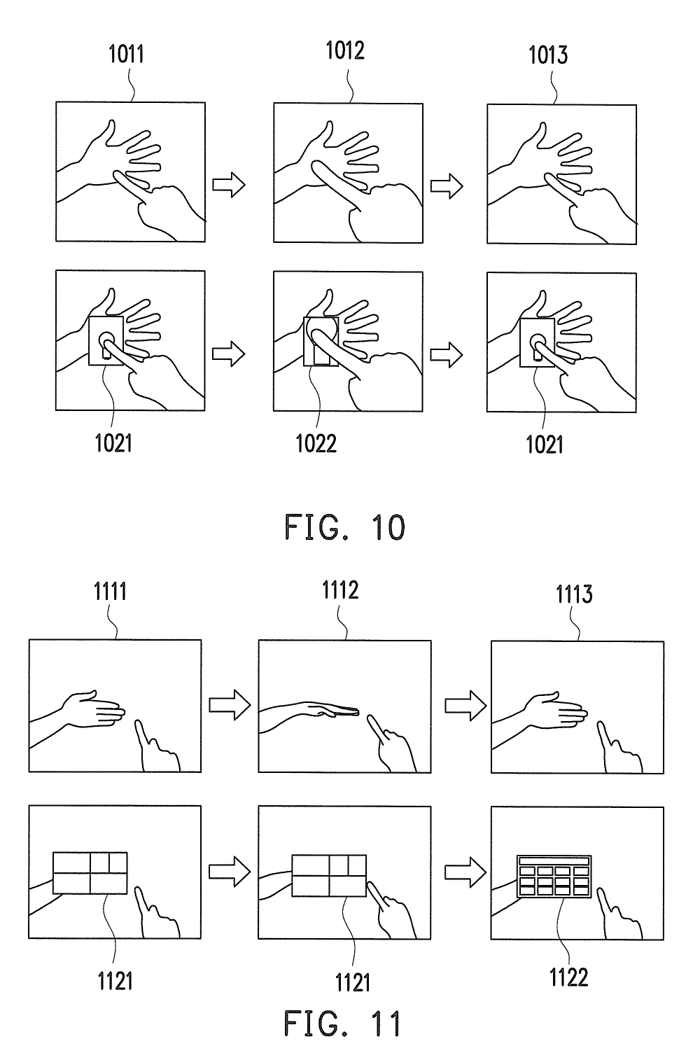

FIG. 11 is a schematic diagram showing a preset gesture performed by the user and the preset function corresponding to the preset gesture according to an embodiment. The preset gesture is turning the palm of the reference hand into a flat position and then turning the palm into a vertical position. The corresponding preset function is switching to another application. As shown in FIG. 11, an application 1121 is displayed in the GUI when the palm is in a vertical position in the image 1111. The application 1121 is still displayed in the GUI when the user turns the palm into a flat position in the image 1112. Next, the GUI switches to another application 1122 when the user turns the palm back to the vertical position in the image 1113.

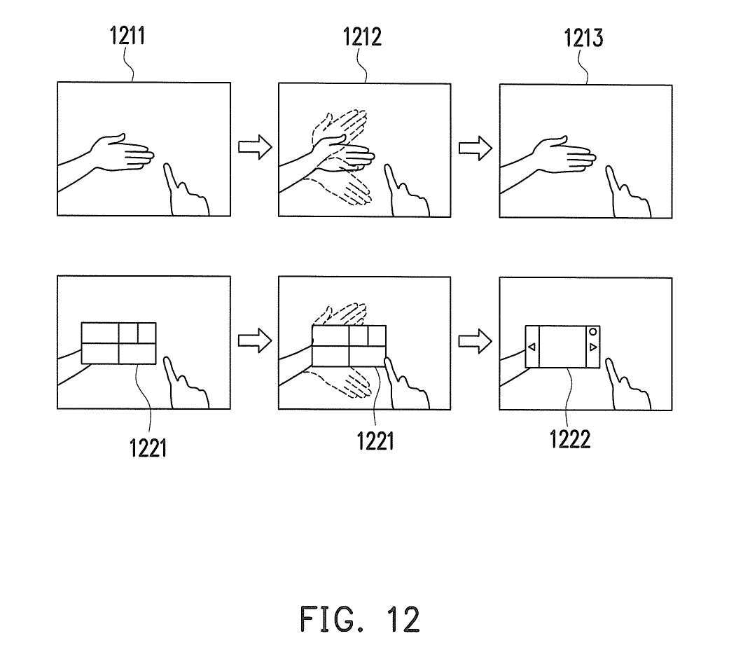

FIG. 12 is a schematic diagram showing a preset gesture performed by the user and the preset function corresponding to the preset gesture according to an embodiment. The preset gesture is swinging the palm of the reference hand vertically. The corresponding preset function is switching to another application. As shown in FIG. 12, an application 1221 is displayed in the GUI when the palm is still in the image 1211. The application 1221 is still displayed in the GUI when the user swings the palm vertically in the image 1212. Next, the GUI switches to another application 1222 and the palm is still again in the image 1213.

It will be apparent to those skilled in the art that various modifications and variations can be made to the disclosed embodiments. It is intended that the true scope of the disclosure is indicated by the following claims and their equivalents.

What is claimed is:

1. A mobile device, comprising:
a camera unit, taking an image of a finger and a surface;
a sensor unit, generating a sensor signal in response to a motion of the finger, wherein the taking of the image and the generation of the sensor signal are synchronous;
a see-through display, displaying a graphical user interface (GUI) on the surface; and
a processor, coupled to the camera unit, the sensor unit, and the see-through display, using both of the image and the sensor signal to detect a touch of the finger on the surface, and adjusting the GUI in response to the touch.

2. The mobile device of claim 1, wherein the camera unit comprises two cameras configured to take stereo images of the finger and the surface, wherein the processor uses the stereo images to estimate a distance between the finger and the surface, and wherein the processor uses the distance as an auxiliary to detect the touch.

3. The mobile device of claim 1, wherein the see-through display displays the GUI on the surface when the processor identifies the surface in the image.

4. The mobile device of claim 1, wherein the processor analyzes the sensor signal to detect the touch when the processor identifies both of the finger and the surface in the image, wherein the processor ignores the sensor signal and does not attempt to detect the touch when processor fails to identify at least one of the finger and the surface in the image.

5. The mobile device of claim 1, wherein the processor starts identifying and tracking a fingertip of the finger after the processor identifies the finger in the image, wherein the processor analyzes the sensor signal to detect the touch when the fingertip is in a touch-operable area of the GUI, wherein the processor ignores the sensor signal and does not attempt to detect the touch when processor fails to identify the fingertip or when the fingertip is in a non-touch-operable area of the GUI.

6. The mobile device of claim 1, wherein the processor starts identifying and tracking a fingertip of the finger after the processor identifies the finger in the image, wherein the processor confirms the touch when the fingertip is in a touch-operable area of the GUI and either a magnitude of the sensor signal is larger than a preset threshold or a waveform of the sensor signal matches a preset waveform.

7. The mobile device of claim 6, wherein the sensor unit comprises a temperature sensor configure to measure an ambient temperature of the finger, wherein the sensor unit further comprises a humidity sensor configure to measure an ambient humidity of the finger, wherein the processor adjusts the preset threshold according to the ambient temperature and the ambient humidity.

8. The mobile device of claim 1, wherein the processor detects a multiple click of the finger on the surface by analyzing the image to confirm a position of the multiple click and analyzing the sensor signal to confirm a number of clicks of the finger on the surface, wherein the processor performs a preset function in response to the multiple click.

9. A method for controlling a graphical user interface (GUI) of a mobile device, comprising:
taking an image of a finger and a surface;
generating a sensor signal in response to a motion of the finger, wherein the taking of the image and the generation of the sensor signal are synchronous;
displaying the GUI on the surface;
using both of the image and the sensor signal to detect a touch of the finger on the surface; and
adjusting the GUI of the mobile device in response to the touch.

10. The method of claim 9, further comprising:
taking stereo images of the finger and the surface;
using the stereo images to estimate a distance between the finger and the surface; and
using the distance as an auxiliary to detect the touch.

11. The method of claim 9, wherein the step of displaying the GUI comprises:
displaying the GUI on the surface when the processor identifies the surface in the image.

12. The method of claim 9, further comprising:
analyzing the sensor signal to detect the touch when both of the finger and the surface are identified in the image; and
ignoring the sensor signal and not attempting to detect the touch when failing to identify at least one of the finger and the surface in the image.

13. The method of claim 9, further comprising:
starting identifying and tracking a fingertip of the finger after identifying the finger in the image;
analyzing the sensor signal to detect the touch when the fingertip is in a touch-operable area of the GUI; and
ignoring the sensor signal and not attempting to detect the touch when failing to identify the fingertip or when the fingertip is in a non-touch-operable area of the GUI.

14. The method of claim 9, further comprising:
starting identifying and tracking a fingertip of the finger after identifying the finger in the image; and
confirming the touch when the fingertip is in a touch-operable area of the GUI and either a magnitude of the sensor signal is larger than a preset threshold or a waveform of the sensor signal matches a preset waveform.

15. The method of claim 14, further comprising:
measuring an ambient temperature and an ambient humidity of the finger;
adjusting the preset threshold according to the ambient temperature and the ambient humidity.

16. The method of claim 9, further comprising:
detecting a multiple click of the finger on the surface by analyzing the image to confirm a position of the multiple click and analyzing the sensor signal to confirm a number of clicks of the finger on the surface; and
performing a preset function in response to the multiple click.

17. The method of claim 9, further comprising:
detecting a preset motion of the finger on the surface by tracking a motion of the finger in the image and analyzing the sensor signal to confirm continued contact of the finger on the surface; and
performing a preset function in response to the preset motion.
